(19) United States
(12) Patent Application Publication
(10) Pub. No.: US 2008/0248944 A1
(43) Pub. Date: Oct. 9, 2008

(54) Amine-Containing Catalyst Ink For Fuel Cells

(75) Inventors: Sven Thate, Neuleiningen (DE); Sigmar Brauninger, Hemsbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/093,460

(22) PCT Filed: Nov. 13, 2006
(86) PCT No.: PCT/EP2006/068368

§ 371 Date: May 13, 2008

(30) Foreign Application Priority Data
Nov. 14, 2005 (DE) 10 2005 054 149.6

(51) Int. Cl. H01M 4/88; B01J 31/00

(52) U.S. Cl. 502/101; 502/150

(57) ABSTRACT

The present invention relates to a catalyst ink for producing membrane-electrode assemblies for polymer electrolyte fuel cells which comprises, apart from the customary components catalyst material, acidic ionomer and solvent, an additive component comprising at least one low molecular weight organic compound which comprises at least two basic nitrogen atoms. The invention further relates to processes for producing such catalyst inks and their use for producing membrane-electrode assemblies for polymer electrolyte fuel cells.

The present invention relates to catalyst inks, processes for producing them and their use, in particular for producing membrane-electrode assemblies for polymer electrolyte fuel cells and polymer electrolyte membrane electrolysises.

In fuel cells, a fuel is converted into electric power, heat and water by means of an oxidant at separate locations at two electrodes. As fuel, it is possible to use hydrogen or a hydrogen-rich gas and also liquid fuels such as methanol, ethanol, formic acid, ethylene glycol, etc., while oxygen or air is used as oxidant. The energy conversion process in the fuel cell has a high efficiency. Fuel cells are therefore gaining increasing importance, especially in combination with electric motors as alternatives to conventional internal combustion engines. Owing to their compact construction and power density, polymer electrolyte fuel cells (PEM fuel cells) are particularly suitable for use in motor vehicles.

In general, a PEM fuel cell is made up of a stack of membrane-electrode assemblies (MEAs) between which bipolar plates for supply of gas and conduction of electric current are usually arranged. An MEA is usually made up of a polymer electrolyte membrane which is provided on both sides with a catalyst layer (catalyst coated membrane, CCM) to which a gas diffusion layer (GDL) is in each case applied. One of the abovementioned catalyst layers serves as anode for the oxidation of hydrogen and the second of the abovementioned catalyst layers serves as cathode for the reduction of oxygen. The gas diffusion layers are generally made up of carbon fiber paper or carbon nonwoven and have a high porosity, so that these layers allow ready access of the reaction gases to the catalyst layers and make it possible for the cell current to be conducted away readily.

To obtain a very good bond between the polymer electrolyte membrane and the catalyst layers which are generally applied to both sides (anode and cathode) with very good contacting of the anode and the cathode with the membrane, the catalyst layer is usually applied to the membrane in the form of a catalyst ink which is frequently made up of an electrocatalyst, an electron conductor, a polyelectrolyte and solvent.

Catalyst inks are known in the prior art. Numerous attempts have been made to obtain improved properties of catalyst inks.

M. Uchida et al., J. Electrochem. Soc., 142 (1995), 463-468, vary numerous solvents which are to form the basis of catalyst inks. These include simple esters, ethers, acetones and ketones, amines, acids, alcohols, glycerols and hydrocarbons.

EP-A 0 731 520 proposes using an aqueous liquid which is essentially free of organic constituents as solvent.

EP-A 1 536 504 proposes monohydric and polyhydric alcohols, glycols such as glycol ether alcohols and glycol ethers as organic solvent for use in catalyst inks.

According to EP-A 1 176 652, linear dialcohols, in particular, are said to be suitable as further solvent components in addition to water.

WO-A 2004/098773 discloses catalyst pastes, which is another term for catalyst inks, which comprise basic polymers in order to bind the acetic ion exchangers customary in catalyst inks so as to achieve a significant increase in the viscosity. Basic polymers proposed are polyethylenimine and also polymers comprising monomer units such as pyridine, 4-vinylpyridine, 2-vinylpyridine or pyrrole. However, a disadvantage here is that the basic polymer cannot be removed or can be removed only incompletely from the electrode layer and part of the acid groups of the acidic polymer thus remain blocked.

Despite the numerous attempts to obtain catalyst inks having improved properties, there is still a need to provide alternative catalyst inks which display at least some improved properties compared to the prior art, in particular in respect of the thickening of the ink, its cohesion and adhesion to the substrate and also spreading and drying behavior.

It is therefore an object of the present invention to provide a catalyst ink which has the abovementioned improved properties.

This object is achieved by a catalyst ink for producing membrane-electrode assemblies for polymer electrolyte fuel cells comprising
a catalyst component comprising at least one catalyst material;
an ionomer component comprising at least one acidic ionomer;
if appropriate, a solvent component comprising at least one solvent and
an additive component comprising at least one low molecular weight organic compound which comprises at least two basic nitrogen atoms.

It has surprisingly been found that due to the at least two basic nitrogens in the organic compound, these can crosslink with the acid groups of the ionomer, resulting in thickening of the ink and high cohesion of the ink and adhesion to the membrane. During drying, this crosslinking can lead to avoidance of cracks. In addition, good adhesion of the ink to the membrane occurs as a result of the acid-base interaction between ink and membrane surface. Likewise, the amine can be removed completely by activation of the electrode layer with a dilute acid, which can occur at best incompletely in the case of polymers. Particularly when the organic compound has a low boiling point, it can also be removed by increasing the temperature and/or applying a reduced pressure.

In the catalyst ink of the invention, the additive component is formed by at least one low molecular weight organic compound which comprises at least two basic nitrogen atoms. The component can likewise comprise a mixture of such compounds.

Basic nitrogen atoms are primary, secondary and tertiary amine functions. The nitrogen atoms can be constituents of a chain or a ring which is part of the organic compound or forms the organic compound and/or can be bound as functional groups to such a skeleton.

It is important to the invention that at least two such nitrogen atoms are present in order to provide the “crosslinking” property opposite the acidic ionomers. However, a larger number of nitrogen atoms can also be present. The at least one low molecular weight organic compound preferably comprises at least two, three, four, or five nitrogen atoms. The at least one low molecular weight organic compound more preferably comprises at least two, three or four basic nitrogen atoms. Further preference is given to the at least one low molecular weight organic compound comprising at least two or three, in particular precisely two, nitrogen atoms.

It is preferred that the at least one low molecular weight organic compound has a molecular weight of less than 500 g/mol. If the additive component is to be formed by more than one low molecular weight organic compound, it is sufficient for at least one organic compound to have this property. However, preference is given to all low molecular weight organic compounds of the additive component having this feature.

The molecular weight is preferably less than 400 g/mol, more preferably less than 300 g/mol, even more preferably less than 250 g/mol, even more preferably less than 200 g/mol and in particular less than 150 g/mol.

The at least one organic compound is derived, for example, from a saturated or unsaturated, aromatic or nonaromatic, branched or unbranched, cyclic or acyclic or both partly cyclic and partly acyclic hydrocarbon having from 4 to 32 carbon atoms in which at least two CH groups are replaced by nitrogen atoms and, in addition, one or more CH₂ groups may be replaced by oxygen or sulfur and one or more hydrogen atoms may be replaced by halogen.

Such a hydrocarbon has at least four carbon atoms, with two of these carbon atoms as CH group being replaced by nitrogen atoms. Thus, the simplest compound would be 1,2-ethanediamine (ethylenediamine). Furthermore, the at least one organic compound is preferably derived from a hydrocarbon having not more than 32 carbon atoms. After replacement of two of these carbon atoms by nitrogen, the hydrocarbon skeleton thus has 30 carbon atoms and two nitrogen atoms. It may be pointed out that it is of course possible for more than two CH groups to be replaced by nitrogen atoms.

The skeleton is thus derived from a hydrocarbon which has from 4 to 32 carbon atoms. The at least one organic compound thus has, if it comprises exactly 2 nitrogen atoms, from 2 to 30 carbon atoms. The hydrocarbon preferably has from 4 to 22 carbon atoms, more preferably from 4 to 12 carbon atoms, even more preferably from 4 to 8 carbon atoms.

The hydrocarbon can be saturated and branched or unbranched. Examples of such hydrocarbons are alkanes, such as n-butane, i-butane, pentane, 2-methylbutane, hexane, heptane, octane, nonane, decane, undecane or dodecane.

Unsaturated, branched or unbranched acyclic compounds are, for example, alkenes and alkynes or hydrocarbons having C—C double and/or triple bonds. Examples are 1-butane, 2-butene, 1-pentene, 2-pentene, hexene and heptene, 1-butyne, 2-butyne, 1-pentyne, 2-pentyne, hexyne or heptyne.

Aromatic hydrocarbons are, in particular, benzenes, naphthalenes and phenantrenes.

Nonaromatic cyclic compounds are, for example, cyclohexane, decalin or similar compounds.

When a plurality of CH₂ groups are replaced by oxygen or sulfur, it should not be the case that two adjacent CH₂ groups are replaced. Furthermore, one or more hydrogen atoms can be replaced by halogen. Halogens are in this case fluorine, chlorine, bromine and iodine. The halogen is preferably fluorine. The hydrocarbon compound can be monohalogenated, dihalogenated, polyhalogenated or perhalogenated.

Preference is also given to the at least one organic compound being a C₄-C₃₂-alkane in which at leas two CH groups have been replaced by nitrogen or benzene having at least two —NR₂ groups or cyclohexane having at least two —NR₂ groups, where the radicals R are each, independently of one another, H or C₁-C₆-alkyl.

The alkane is preferably a C₄-C₂₂-alkane, more preferably a C₄-C₁₂-alkane, even more preferably a C₄-C₈-alkane, with the indices indicating the respective minimum and maximum number of carbon atoms.

C₁-C₆-alkyl is an alkyl radical having from 1 to 6 carbon atoms, for example methyl, ethyl, n-propyl, i-propyl, n-1-butyl, n-2-butyl, i-butyl, t-butyl, pentyl, hexyl.

The simplest alkane which comes into question is thus butane in which two CH groups have been replaced by nitrogen. The simplest compound is therefore ethylenediamine.

Preference is also given to benzene and cyclohexane having, in each case, two optionally alkylated amino groups. Mention may here be made of 1,2-diaminobenzene, 1,3-diaminobenzene, 1,4-diaminobenzene, 1,2-diaminocyclohexane, 1,3-diaminocyclohexane and 1,4-diaminocyclohexane and also their N-alkylated derivatives. If the amino groups are alkylated, the alkyl group is preferably a methyl group.

The at least one low molecular weight organic compound is preferably a diamine.

Preferred diamines are 1,4-phenylenediamine, 1,2-phenylenediamine, 1,3-phenylenediamine, 1,2-cyclohexanediamine, 1,3-cyclohexanediamine, 1,4-cyclohexanediamine, 3,6-diazaoctane-1,8-diamine, diethylenediamine, 4,9-dioxadodecane-1,12-diamine, ethylenediamine, N,N-diethylethanediamine, N,N,N′,N′-tetramethyl-1,3-propanediamine, N,N-diethyl-N′,N′-dimethyl-1,3-propanediamine, propylenediamine, 1,2-propanediamine, N,N-dimethyl-1,3-propanediamine, N,N-diethylpropane-1,3-diamine, N-cyclohexyl-1,3-propanediamine, N-methyl-1,3-propanediamine, trimethylenediamine, 1,1′-biphenyl-4,4′-diamine, 1,7-heptanediamine, isophoronediamine, 2-methylpenta-methylenediamine, 4-methyl-1,2-phenyldiamine, 4-methyl-1,3-phenylenediamine, naphthalene-1,5-diamine, naphthalene-1,8-diamine, neopentanediamine, 2-nitro-1,4-phenylenediamine, 4-nitro-1,2-phenylenediamine, 4-nitro-1,3-phenylenediamine, nonamethylenediamine, 1,3-propanediamine, 3,5-diaminobenzoic acid, 3,4-diaminobenzoic acid, 4,4′-diaminobenzophenone, 1,4-daiminobutane, 2,4-diamino-6-chloropyrimidine, 4,4′-diaminodicyclohexylmethane, 4,4′-diamino-3,3′-dimethyldicylcohexylmethane, 2,2′-diaminodiethylamine, 1,8-diamino-3,6-dioxaoctane, bis(4-aminophenyl) ether, 4,4′-diaminodiphenylmethane, bis(3-aminophenyl)sulfone, bis(4-aminophenyl)sulfone, 1,6-diaminohexane, 4,5-diamino-6-hydroxy-2-mercaptopyridine, 2,4-diamino-6-hydroxypyrimidine, diaminomaleic dinitrile, 4,6-diamino-2-mercaptopyrimidine, 1,5-diamino-2-methyl-pentane, 1,9-diaminononane, 1,8-diaminooctane, 2,4-diaminophenol, 2,6-diamino-4-phenyl-1,3,5-triazine, 2,3-diaminopyridine, 2,6-diaminopyridine, 2,3-diaminopropionic acid, 3,4-diaminopyridine, 4,6-diamino-2-pyrimidine thiol, 3,5-diamino-1,2,4-triazole, 1,13-diamino-4,7,10-trioxatridecane and also 2,5-diaminovaleric acid and their N-alkylated derivatives.

Preference is also given to polyamines such as triamines and tetraamines. Examples are diethylenetriamine, N-(2-aminoethyl)-1,3-propanediamine, dipropylenetriamine, N,N-bis(3-aminopropyl)methylamine, N,N′-bis(3-amino-propyl)ethylenediamine.

Particularly preferred organic compounds are ethylenediamine, diaminopropane (propyldiamine), benzenediamine, N,N,N′,N′-tetramethylpropanediamine and N,N,N′,N′-tetramethylethylenediamine (TMEDA) hexamethylenediamine and octamethylenediamine.

The at least one low molecular weight organic compound preferably has a boiling point below 350° C. If a plurality of such organic compounds are present, it is sufficient for at least one of these compounds to meet the conditions. However, preference is given to all of the organic compounds of the additive component meeting this condition.

The boiling point is preferably less than 300° C., more preferably less than 250° C. and in particular less than 200° C.

In addition to the additive component comprising at least one low molecular weight organic compound which comprises at least two basic nitrogen atoms, an ionomer component comprising at least one acidic ionomer is present. Preference is here given to the proportion of the additive component being from 0.001 to 50% by weight, based on the total weight of the catalyst ink. Particular preference is given to from 0.01 to 20% by weight.

Furthermore, it is preferred that the molar ratio of the functional amine groups of the additive component to the acid groups of the ionomer component is from 0.01 to 1000. This is more preferably from 0.1 to 100. In addition to the additive component, the catalyst ink comprises, as mentioned above, an ionomer component comprising at least one acidic ionomer.

It is thus sufficient for one ionomer having acidic properties to be present in the catalyst ink. However, it is likewise possible for the ionomer component to comprise further acidic ionomers. In addition, the ionomer component can also comprise nonacidic ionomers. The ionomers which can be used for the ionomer component of the catalyst ink of the invention are known in the prior art and are disclosed, for example, in WO-A 03/054991. Preference is given to using at least one ionomer having sulfonic acid, carboxylic acid and/or phosphonic acid groups or salts thereof. Suitable ionomers having sulfonic acid, carboxylic acid and/or phosphonic acid groups are likewise known to those skilled in the art. For the purposes of the present invention, sulfonic acid, carboxylic acid and/or phosphonic acid groups are groups of the formulae —SO₃X, —COOX and —PO₃X₂, where X is H, NH₄⁺, NH₃R^{′+}, NH₂R^{′}₃⁺, NHR′₃⁺, NR′₄⁺, Na⁺, K⁺ or Li⁺ and R′ is any radical, preferably an alkyl radical, which, if appropriate, bears one or more further radicals which can release protons under conditions customarily prevailing in fuel cells.

Preferred ionomers are, for example, polymers which comprise sulfonic acid groups and are selected from the group consisting of perfluorinated sulfonated hydrocarbons such as Nafion® from E. I. Dupont, sulfonated aromatic polymers such as sulfonated polyaryl ether ketones such as polyether ether ketones (sPEEK), sulfonated polyether ketones (sPEK), sulfonated polyether ketone ketones (sPEKK), sulfonated polyether ether ketone ketones (sPEEKK), sulfonated polyether ketone ether ketone ketones (sPEKEKK), sulfonated polyarylene ether sulfones, sulfonated polybenzobisbenzazoles, sulfonated polybenzothiazoles, sulfonated polybenzimidazoles, sulfonated polyamides, sulfonated polyether imides, sulfonated polyphenylene oxides, e.g. poly-2,6-dimethyl-1,4-phenylene oxides, sulfonated polyphenylene sulfides, sulfonated phenol-formaldehyde resins (linear or branched) sulfonated polystyrenes (linear or branched), sulfonated polyphenylenes and further sulfonated aromatic polymers.

The sulfonated aromatic polymers can be partially fluorinated or perfluorinated. Further sultonated polymers comprise polyvinylsulfonic acids, copolymers made up of acrylonitrile and 2-acrylamido-2-methyl-1-propanesulfonic acids, acrylonitrile and vinylsulfonic acids, acrylonitrile and styrenesulfonic acids, acrylonitrile and methacryloxyethyleneoxypropanesulfonic acids, acrylonitrile and methacryloxyethyleneoxytetrafluoroethylenesulfonic acids, etc. The polymers can once again be partially fluorinated or perfluorinated. Further groups of suitable sulfonated polymers comprise sulfonated polyphosphazenes such as poly(sulfophenoxy)phosphazenes or poly(sulfoethoxy)phosphazenes. The polyphosphazene polymers can be partially fluorinated or perfluorinated. Sulfonated polyphenylsiloxanes and copolymers thereof, poly(sulfoalkoxy)phosphazenes, poly(sulfotetrafluoroethoxypropoxy)siloxanes are likewise suitable.

Examples of suitable polymers comprising carboxylic acid groups comprise polyacrylic acid, polymethacrylic acid and any copolymers thereof. Suitable polymers are, for example, copolymers with polyvinylimidazole or acrylonitrile. The polymers can once again be partially fluorinated or perfluorinated.

Suitable polymers comprising phosphonic acid groups are, for example, polyvinyl-phosphonic acid, polybenzimidazolephosphonic acid, phosphonated polyphenylene oxides, e.g. poly-2,6-dimethylphenylene oxides, etc. The polymers can be partially fluorinated or perfluorinated.

Apart from cation-conducting (acidic) polymers, anion-conducting (basic) polymers are also conceivable, but the proportion of the acidic ionomers has to predominate. These bear, for example, tertiary amine groups or quaternary ammonium groups. Examples of such polymers are described in U.S. Pat. No. 6,183,914; JP-A 11273695 and in Slade et al., J. Mater. Chem. 13 (2003), 712-721.

Furthermore, acid-base blends as disclosed, for example, in WO 99/54389 and WO 00/09588 are also suitable as ionomers. These are generally polymer mixtures comprising a polymer comprising sulfonic acid groups and a polymer bearing primary, secondary or tertiary amino groups, as are disclosed in WO 99/54389, or polymer mixtures obtained by mixing polymers which comprise basic groups in the side chain with polymers comprising sulfonate, phosphonate or carboxylate groups (acid or salt form). Suitable polymers comprising sulfonate, phosphonate or carboxylate groups have been mentioned above (see polymers comprising sulfonic acid, carboxylic acid or phosphonic acid groups). Polymers with basic groups in the side chain are those which are obtained by side-chain modification of aryl-main-chain engineering polymers which have arylene-comprising N-basic groups, where aromatic ketones and aldehydes comprising tertiary basic N groups (e.g. tertiary amine or basic N-comprising heterocyclic aromatic compounds such as pyridine, pyrimidine, triazine, imidazole, pyrazole, triazole, thiazole, oxazole, etc.) are joined to the metallated polymer.

Here, the metal alkoxide formed as intermediate can in a further step either be protonated by means of water or etherified by means of haloalkanes (W00/09588).

The abovementioned ionomers can also be crosslinked. Suitable crosslinking reagents are, for example, epoxide crosslinkers such as the commercially available Decanole®. Suitable solvents in which crosslinking can be carried out can be selected, inter alia, as a function of the crosslinking reagent and the ionomers used. Examples of suitable solvents are aprotic solvents such as DMAc (N,N-dimethylacetamide), DMF (dimethylformamide), NMP (N-methylpyrrolidone) or mixtures thereof. Suitable crosslinking agents are known to those skilled in the art.

Preferred ionomers are the abovementioned polymers comprising sulfonic acid groups. Particular preference is given to perfluorinated sulfonated hydrocarbons such as Nafion®, sulfonated aromatic polyether ether ketones (sPEEK), sulfonated polyether ether sulfones (sPES), sulfonated polyetherimides, sulfonated polybenzimidazoles, sulfonated polyether sulfones and mixtures of the polymers mentioned. Particular preference is given to perfluorinated sulfonated hydrocarbons such as Nafion® and sulfonated polyether ether ketones (sPEEK). These can be used either alone or in mixtures with other ionomers. It is likewise possible to use copolymers which comprise blocks of the abovementioned polymers, preferably polymers comprising sulfonic acid groups. An example of such a block copolymer is sPEEK-PAMD.

The degree of functionalization of the ionomers comprising sulfonic acid, carboxylic acid and/or phosphonic acid groups is generally from 0 to 100%, preferably from 0.1 to 100%, more preferably from 30 to 70%, particularly preferably from 40 to 60%.

Sulfonated polyether ether ketones which are particularly preferably used have degrees of sulfonation of from 0 to 100%, more preferably from 0.1 to 100%, even more preferably from 30 to 70%, particularly preferably from 40 to 60%. Here, a degree of sulfonation of 100% or a functionalization of 100% means that each repeating unit of the polymer comprises a functional group, in particular a sulfonic acid group.

The abovementioned ionomers can be used either alone or in mixtures in the catalyst inks of the invention. It is possible to use mixtures which comprise the at least one ionomer together with further polymers or other additives, e.g. inorganic materials, catalysts or stabilizers.

Methods of preparing the abovementioned ion-conducting polymers which are suitable as ionomer are known to those skilled in the art. Suitable processes for preparing sulfonated polyaryl ether ketones are disclosed, for example, in EP-A 0 574 791 and WO 2004/076530.

Some of the abovementioned ion-conducting polymers (ionomers) are commercially available, e.g. Nafion® from E. I. Dupont. Further suitable commercially available materials which can be used as ionomers are perfluorinated and/or partially fluorinated polymers such as “Dow Experimental Membrane” (Dow Chemicals USA), Aciplex® (Asahi Chemicals, Japan), Raipure R-1010 (Pall Rai Manufacturing Co. USA) Flemion (Asahi Glas, Japan) and Raymion® (Chlorin Engineering Cop., Japan).

In addition, the catalyst ink comprises a catalyst component which comprises at least one catalyst material. However, the catalyst component of the catalyst ink of the invention can also comprise a plurality of different catalyst materials.

Suitable catalyst materials are known in the prior art. Suitable catalyst materials are generally platinum group metals such as platinum, palladium, iridium, rhodium, ruthenium or mixtures thereof. The catalytically active metals or mixtures of various metals can comprise further alloying additions such as cobalt, chromium, tungsten, molybdenum, vanadium, iron, copper, nickel, silver, gold, etc.

The choice of the platinum group metal used depends on the planned field of use of the finished fuel cell or electrolysis cell. If a fuel cell which is to be operated using hydrogen as fuel is to be produced, it is sufficient for only platinum to be used as catalytically active metal. The catalyst ink used in this case comprises platinum as active noble metal. This catalyst layer can be used both for the anode and for the cathode in a fuel cell.

The catalyst component can be supported on electron conductors such as carbon black, graphite, carbon fibers, carbon nanomers, carbon foams.

If, on the other hand, a fuel cell which uses a reformate gas comprising carbon monoxide as fuel is to be produced, it is advantageous for the anode catalyst to have a very high resistance to poisoning by carbon monoxide. In such a case, electrocatalysts based on platinum/ruthenium are preferably used. In the production of a direct methanol fuel cell, too, preference is given to using electrocatalysts based on platinum/ruthenium. In such a case, the catalyst ink used for producing the anode layer in a fuel cell therefore preferably comprises both metals. To produce a cathode layer, it is in this case generally sufficient for platinum alone to be used as catalytically active metal. It is thus possible to use the same catalyst ink for coating both sides of an ion-conducting polymer electrolyte membrane. However, it is likewise possible to use different catalyst inks for coating the surfaces of the polymer electrolyte membrane.

Furthermore, the catalyst ink can comprise a solvent component comprising at least one solvent. If the additive component comprises at least one liquid organic compound, the solvent component can be omitted since these properties are taken over by the additive component.

Suitable solvents are ones in which the ionomer can be dissolved or dispersed. Such solvents are known to those skilled in the art. Examples of suitable solvents are water, monohydric and polyhydric alcohols, N-comprising polar solvents, glycols and glycol ether alcohols and glycol ethers. Particularly suitable solvents are, for example, propylene glycol, dipropylene glycol, glycerol, ethylene glycol, hexylene glycol, dimethylacetamide, N-methylpyrrolidone, water and mixtures thereof.

In addition, the catalyst ink can comprise further additives. These can be wetting agents, leveling agents, antifoams, pore formers, stabilizers, pH modifiers and other substances.

Furthermore, an electron conductor component comprising at least one electron conductor is comprised in the catalyst ink of the present invention. Suitable electron conductors are known to those skilled in the art. The electron conductor is generally composed of electrically conductive carbon particles. As electrically conductive carbon particles, it is possible to use all carbon materials having a high electrical conductivity and a large surface area which are known in the field of fuel cells and electrolysis cells. Preference is given to carbon blacks, graphite or activated carbons.

The weight ratio of electron conductor to ionomer in the catalyst ink can be from 10:1 to 1:10, preferably from 5:1 to 1:2. The weight ratio of catalyst material to electron conductor can be from 1:10 to 5:1.

The solids content of the ink of the invention is preferably from 1 to 60% by weight, more preferably from 5 to 50% by weight and particularly preferably from 10 to 40% by weight.

The process of the invention further provides a process for producing a catalyst ink according to the invention, which comprises the steps:
contacting of a catalyst component comprising at least one catalyst material, an ionomer component comprising at least one acidic ionomer, an additive component comprising at least one low molecular weight organic compound which comprises at least two basic nitrogen atoms and, it appropriate, a solvent component comprising at least one solvent; and
dispersion of the mixture.

The present invention further provides a process for producing a catalyst ink according to the invention, which comprises the steps:
contacting of a catalyst component, an ionomer component comprising at least one acidic ionomer and, if appropriate, a solvent component comprising at least one solvent;
dispersion of the mixture, and
addition of an additive component comprising at least one low molecular weight organic compound which comprises at least two basic nitrogen atoms and, if appropriate, further solvents to the dispersed mixture.

The at least one low molecular weight organic compound which comprises at least two basic nitrogen atoms is preferably at least partially neutralized with an acid before addition to the ink. The acid in this case is preferably a weak acid, for example carbonic acid, formic acid, acetic acid or a further acid. The neutralized organic compound thus crosslinks more slowly and in a more controlled fashion by means of acid exchange. In addition, CO₂ formation in an after-treatment step (washing of the CCM or MEA in strong acid) can be utilized for pore formation.

The present invention further provides for the use of a catalyst ink according to the invention in the production of membranes coated with a catalyst layer (CCMs), gas diffusion electrodes and membrane-electrode assemblies, with the latter being used for polymer electrolyte fuel cells and in PEM electrolysis.

The catalyst ink is generally applied in homogeneously dispersed form to the ion-conducting polymer electrolyte membrane or gas diffusion layer to produce a membrane-electrode assembly. To produce a homogeneously dispersed ink, it is possible to use known means, for example high-speed stirrers, ultrasound or ball mills.

The homogenized ink can subsequently be applied to an ion-conducting polymer electrolyte membrane by means of various techniques. Suitable techniques are printing, spraying, doctor blade coating, rolling, brushing and painting.

The applied catalyst layer is subsequently dried. Suitable drying methods are, for example, hot air drying, infrared drying, microwave drying, plasma processes and also combinations of these methods.

Apart from the above-described methods of coating the ion-conducting polymer electrolyte membrane, it is also possible to use other methods of applying a catalyst layer to a polymer electrolyte membrane which are known to those skilled in the art.

### EXAMPLE

A catalyst ink according to the invention is produced by combining

1 part of catalyst (70% Pt on carbon),

2 parts of Nafion(D Dispersion (EW100, 10% in water) and

3 parts of deionized water

and dispersing the mixture by means of ultrasound for 60 minutes. One part of TMEDA (50% strength in deionized water) is subsequently stirred in by means of a magnetic stirrer.

1. A catalyst ink for producing membrane-electrode assemblies for polymer electrolyte fuel cells comprising
a catalyst component comprising at least one catalyst material;
an ionomer component comprising at least one acidic ionomer;
an electron conductor component;
optionally, a solvent component comprising at least one solvent and
an additive component comprising at least one low molecular weight organic compound which comprises at least two basic nitrogen atoms.

2. The catalyst ink according to claim 1, wherein the at least one organic compound has a molecular weight of less than 500 g/mol.

3. The catalyst ink according to claim 1, wherein the at least one organic compound is derived from a saturated or unsaturated, aromatic or nonaromatic, branched or unbranched, cyclic or acyclic or both partly cyclic and partly acyclic hydrocarbon having from 4 to 32 carbon atoms in which at least two CH groups are replaced by nitrogen atoms and, in addition, one or more CH₂ groups may be replaced by oxygen or sulfur and one or more hydrogen atoms may be replaced by halogen.

4. The catalyst ink according to claim 3, wherein the at least one organic compound is a C₄-C₃₂-alkane in which at least two CH groups have been replaced by nitrogen or benzene having at least two —NR₂ groups or cyclohexane having at least two —NR₂ groups, where the radicals R are each, independently of one another, H or C₁-C₆-alkyl.

5. The catalyst ink according to claim 4, wherein the at least one organic compound is selected from the group consisting of ethylenediamine, diaminopropane, benzenediamine, tetra-methyl-propanediamine, tetramethylethylenediamine, hexamethylene-diamine and octamethylenediamine.

6. The catalyst ink according to claim 1, wherein the boiling point of the at least one organic compound is below 350° C.

7. The catalyst ink according to claim 1, wherein the proportion of the additive component is from 0.001 to 50% by weight, based on the total weight of the catalyst ink.

8. The catalyst ink according to claim 1, wherein the molar ratio of the functional amino groups of the additive component to the acid groups of the ionomer component is from 0.01 to 1000.

9. A process for producing the catalyst ink according to claim 1, comprising:
contacting of a catalyst component comprising at least one catalyst material, an ionomer component comprising at least one acidic ionomer, an additive component comprising at lest one low molecular weight organic compound which comprises at least two basic nitrogen atoms and, optionally, a solvent component comprising at least one solvent; and
dispersion of the mixture.

10. A process for producing the catalyst ink according to claim 1, comprising:
contacting of a catalyst component, an ionomer component comprising at least one acidic ionomer and, optionally, a solvent component comprising at least one solvent;
dispersion of the mixture, and
addition of an additive component comprising at least one low molecular weight organic compound which comprises at least two basic nitrogen atoms and, optionally, further solvents to the dispersed mixture.

11. A method of producing membranes provided with a catalyst layer (CCMs), gas diffusion electrodes and membrane-electrode assemblies, wherein the catalyst according to claim 1 is used.
